(19) United States
(12) Patent Application Publication
(10) Pub. No.: US 2011/0148058 A1
(43) Pub. Date: Jun. 23, 2011

(54) Stroller

(76) Inventor: Janet Lee Campos, Las Vegas, NV (US)

(21) Appl. No.: 12/967,898

(22) Filed: Dec. 14, 2010

Related U.S. Application Data
(60) Provisional application No. 61/287,335, filed on Dec. 17, 2009.

(51) Int. Cl. B62B 1/08

(52) U.S. Cl. 280/47.12

(57) ABSTRACT

A stroller with a sitting area that is convertible from a smaller seat for a child into a larger seat for an adult. In addition, the stroller sitting area may be converted into a bassinet for a child to lay within. A rocking structure may be provided to permit the sitting area to rock. In addition, the stroller seat may be rotatable from a first position to a second position for rocking either side to side or front to back.

### CROSS-REFERENCE TO RELATED APPLICATIONS

This patent application claims the benefit of U.S. Provisional Patent Application No. 61/287,335, filed Dec. 17, 2009, which is incorporated by reference in its entirety herein.

### BACKGROUND

Strollers for transporting small children are well known in the art. They are typically designed to carry a single child in a seated position, although versions of strollers are available to separately seat more than one child. Strollers have a plurality of wheels and a handle for an adult to push the stroller. Often, for safety and because the child is young, the child is retained in the stroller with a lap restraint.

### BRIEF SUMMARY

The invention provides a stroller with a sitting area that is convertible from a smaller seat for a child into a larger seat for an adult. Strollers are used for transporting children to alleviate the need for the child to walk or an adult to carry the child. In many circumstances, however, a destination may be reached where the child no longer needs to be transported, and instead, the adult and child are located for a period of time. At such a destination, the stroller may be converted to provide a chair for an adult while, for example, the child is permitted to play outside the stroller or the child is held by the adult. In addition, the sitting area may be converted into a bassinet for a child to lay within.

The invention also provides a stroller that may operate as a rocking chair. For example, the stroller may have a rocking mechanism that permits the chair to rock back and forth when a child and/or an adult is sitting in the stroller. The stroller may have a locking mechanism that may be used to make the chair stationary, and thus, prevent the stroller from rocking at certain times. In some embodiments, the stroller seat may be rotatable from a first position to a second position for rocking side to side instead of front to back.

### BRIEF DESCRIPTION OF THE DRAWINGS

FIG. 1 is a perspective view of the stroller with the sitting area converted to have a smaller seat for accommodating a child;

FIG. 2 is an elevational side view of the stroller of FIG. 1 with the sitting area converted to have a smaller seat for accommodating a child;

FIG. 3 is a perspective view of the stroller of FIG. 1 with the sitting area converted to have a larger seat for accommodating an adult and the wheels removed to make the stroller stationary;

FIG. 4 is an elevational side view of the stroller of FIG. 1 with the sitting area rotated with respect to the lower portion of the frame; and

FIG. 5 is a perspective view of another embodiment of a stroller with a foldable wheel arrangement to make the stroller stationary.

### DETAILED DESCRIPTION

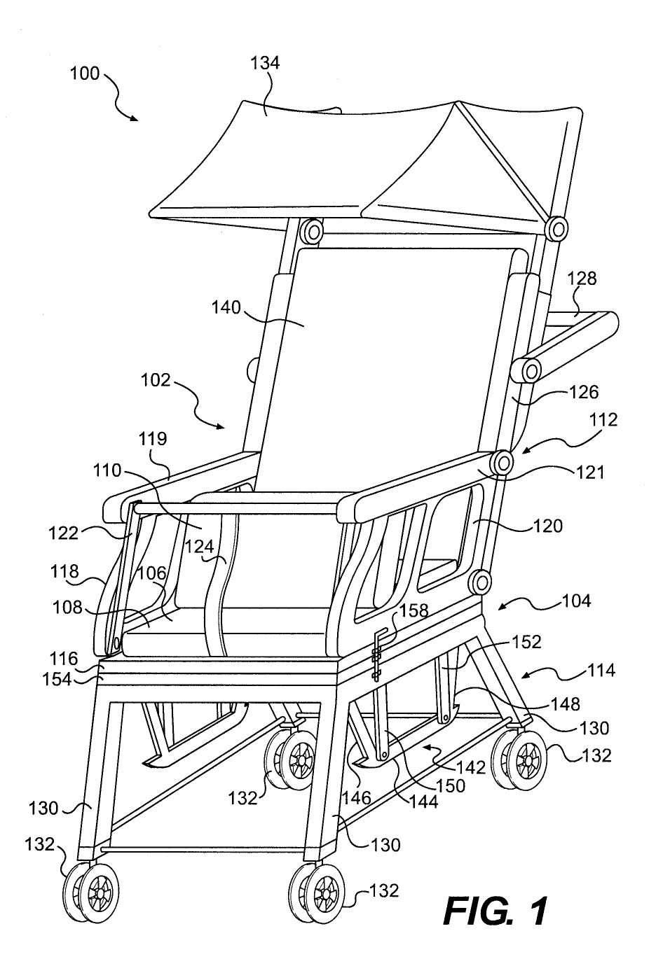

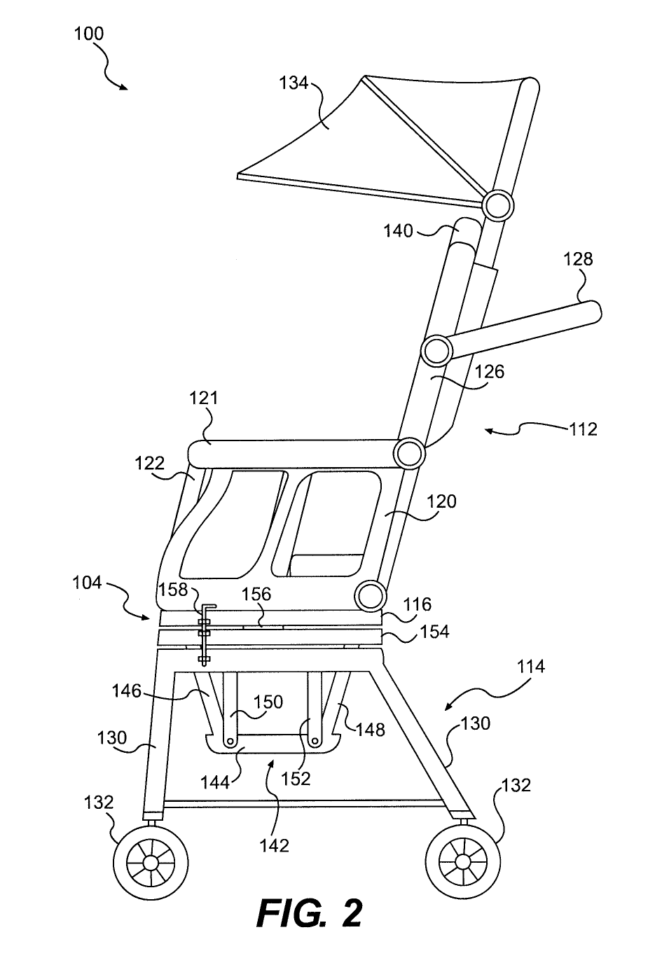

Referring to the figures, FIGS. 1 and 2 show an embodiment of a stroller 100. The stroller 100 includes a sitting area 102 and a frame 104. As shown in FIG. 1, the sitting area 102 includes a seat 106 that provides a place for a child to comfortably sit and securely ride during transport. The seat 106 can include a seat base portion 108 and a seat back portion 110 for accommodating a child. The frame 104 can include an upper portion 112 and a lower portion 114. The upper portion 112 may have a seat support 116 for supporting the sitting area 102. In addition, the upper portion 112 may have sides 118, 120 enclosing the seat 106 to help retain the child within the seat 106 and protect the child. The sides 118, 120 can include arm rests 119, 121.

The upper portion 112 can also include a forward lap bar 122 that a child can use as a grip and which also functions as a forward retaining structure. The forward lap bar 122 may also include a leg divider 124. The forward lap bar 122 may be pivotably attached or otherwise movable such that it can be moved to an alternate position if it is not needed. A restraint, such as a belt with a buckle, can be used to securely retain the child in the stroller. The upper portion 112 can also include a rear side 126. The stroller 100 can have a handle 128 coupled to the rear side 126, which can be used to propel and turn the stroller 100.

The lower portion 114 of the frame may include a structure suitable for supporting the upper portion 112 of the frame 104 above the ground. For example, the lower portion 114 may include a plurality of legs 130. The legs 130 may have wheels 132 disposed at distal ends of the legs 130 for mobilizing the stroller 100. It will be appreciated that the wheels 132 may be coupled to the frame 104 in any suitable manner, and as will be described further herein, the wheels 132 can be removable or otherwise displaceable.

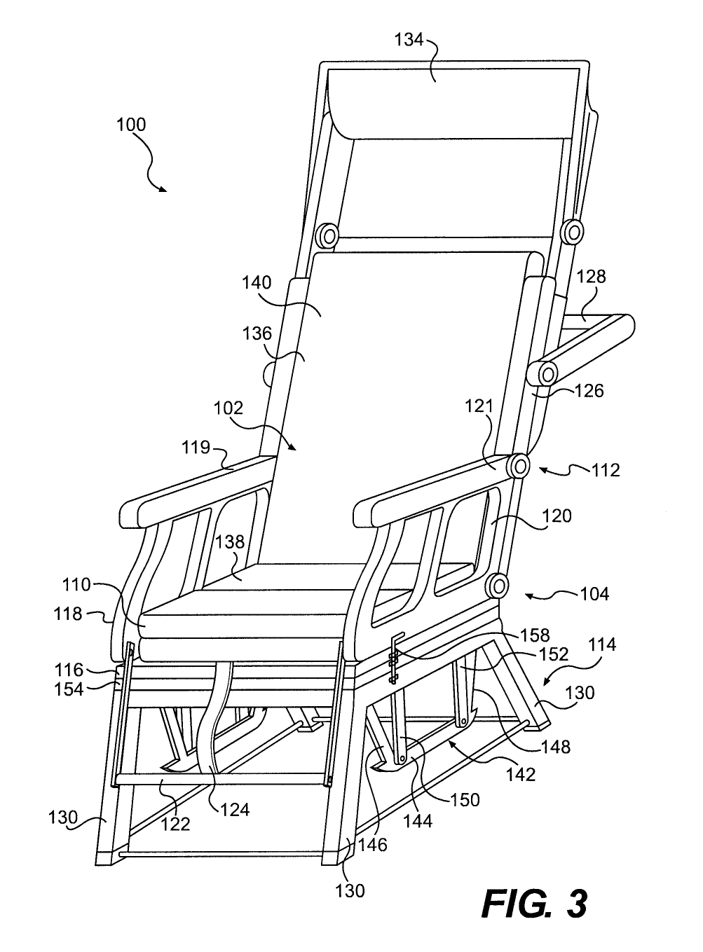

As shown in FIG. 1, the stroller 100 can include a canopy 134 coupled to the frame for partially and/or fully covering the sitting area 102 of the stroller 100. The canopy 134 can be movable such that it can be disposed in any of a variety of positions above the sitting area 102 of the stroller 100. For example, the canopy 134 can be raised or lowered as desired. In addition, as shown in FIG. 3, the canopy 134 may be foldable such that it can be retracted to a position, such as near the handle 128, when the canopy 134 is not in use. In this folded position, the canopy 134 can collapse to a low profile such that it is substantially non-obtrusive to the user. It will be appreciated that the canopy 134 can be any suitable shape or size, and the canopy 134 can be mounted and structured in any suitable manner such that the canopy 134 can be rendered substantially non-obtrusive to a user.

Referring again to FIG. 1, a child can sit on the base portion 108 with his back supported by the back portion 110. In some embodiments, the sitting area 102 may be convertible in a manner such that an adult can sit in the stroller 100. For example, a child can be transported to a location where there may be limited or inadequate adult seating, such as a sports field. Typically, a parent will have to carry a separate piece of equipment to such a location, such as a folding chair, in order to have a suitable and comfortable place to sit. By providing a stroller 100 that can convert into a chair suitable for accommodating an adult, the adult has a convenient place to sit while transporting a minimum amount of equipment.

In order to convert the child seat 106 such that the sitting area 102 is large enough to accommodate an adult, the child seat back portion 110 can be movable to a position that increases the depth of the sitting area 102 to form a larger seat 136. For example, as shown in FIG. 3, the child seat back portion 110 can be folded forward such that it lays flat. In this position, a back side of the child seat back portion 110 can be used to form part of a larger seat base 138 for a larger seat 136. The remaining portion of the larger seat base 138 may be disposed between the child seat back portion 110 and a larger seat back portion 140 that may be coupled to the rear side 126 of the frame 104. It will be appreciated that the stroller 100 could alternatively have a child seat back portion 110 that could be folded backward or otherwise displaced to provide a larger seat 136 having a suitable depth for an adult.

To accommodate the legs of an adult, the forward lap bar 122 can be pivoted downward. In addition, the canopy 134 can be folded back or can be raised upward to a position comfortably above the head of a seated adult. The larger seat 136 can have any suitable depth and width to accommodate a seated adult. It will be appreciated that any suitable structure can be utilized to convert the sitting area 102 from a smaller seat 106 suitable for a child to a larger seat 136 suitable for an adult.

In addition to being able to be used as an adult chair, the convertible sitting area 102 may be used as a bassinet. For example, when the seat back portion 110 is arranged to increase the size of the sitting area 102, the larger seat base 138 can accommodate a laying child. In this way, a more comfortable resting option is enabled for a child to nap in the stroller 100. Although the sides 118, 120 of the upper frame 112 around the sitting area 102 are shown with openings, it will be appreciated that those openings can be covered (such as with a removable fabric) or alternately, the sides 118, 120 could be provided without large openings or any openings, such that a child cannot reach through the openings. Unlike when the smaller seat 108 is converted into a larger seat 136 for use as a larger chair, the forward lap bar 122 can be used to at least partially enclose the sitting area 102 for the child to lay when used as a bassinet. The forward lap bar 122 may also be selectively covered, such as with a removable fabric.

The stroller 100 may include a suitable structure for rocking the sitting area 102. The rocking motion can occur whether the sitting area 102 is converted to accommodate a child or an adult. The rocking motion can be used, for example, to placate a child, or alternatively, to make the chair more relaxing for an adult. The stroller 100 may be structured such that the rocking motion is only enabled at certain desired times. For example, a locking mechanism 158, such as a latch or physical stop, may be provided to restrict the rocking motion when desired. The rocking structure may be either a glider type rocker or an arcuate style rocker. It will be appreciated, however, that any suitable rocking mechanism may be utilized with the stroller.

If a glider type rocker mechanism is utilized, the glider rocking mechanism may have any suitable structure. For example, referring to FIGS. 1-3, the glider rocking mechanism 142 may include a linkage on each side of the stroller 100. The glider rocking mechanism 142 may be disposed between the upper portion 112 of the frame 104 and the lower portion 114 of the frame 104 such that the sitting area 102 can swing in a rocking motion. The linkage may include a lower swing member 144 coupled to members 146, 148, which are themselves coupled to the upper portion 112 below the sitting area 102. Pivoting members 150, 152 can be pivotably coupled at each end to the swing member 144 and pivotably coupled at each other end to the lower portion 114 of the frame 104.

Alternatively, an arcuate rocker mechanism may have an arcuate base that rests on a generally planar surface. The seat can rock forward and backward as the arcuate base tilts respectively forward and backward on the planar surface.

In some embodiments, the sitting area 102 can be rotatable from a first position to a second position such that the rocking motion can be changed between a front and back rocking motion to a side to side rocking motion. Referring to FIG. 2, the seat support can include a first platform, such as the seat support 116, and a second platform 154. The first platform 116 can directly support the sitting area, and the second platform 154 can be disposed below the first platform 116. The members 146, 148 can attach to the underside of the second platform 154. The first and second platforms 116, 154 can be coupled to one another by one or more connectors 156 that permit the first platform 116 to rotate with respect to the second platform 154. The connector(s) 156 can include any suitable structure for rotating the sitting area 102 such as may be employed, for example, to rotate a rotating table (i.e., a “lazy susan”).

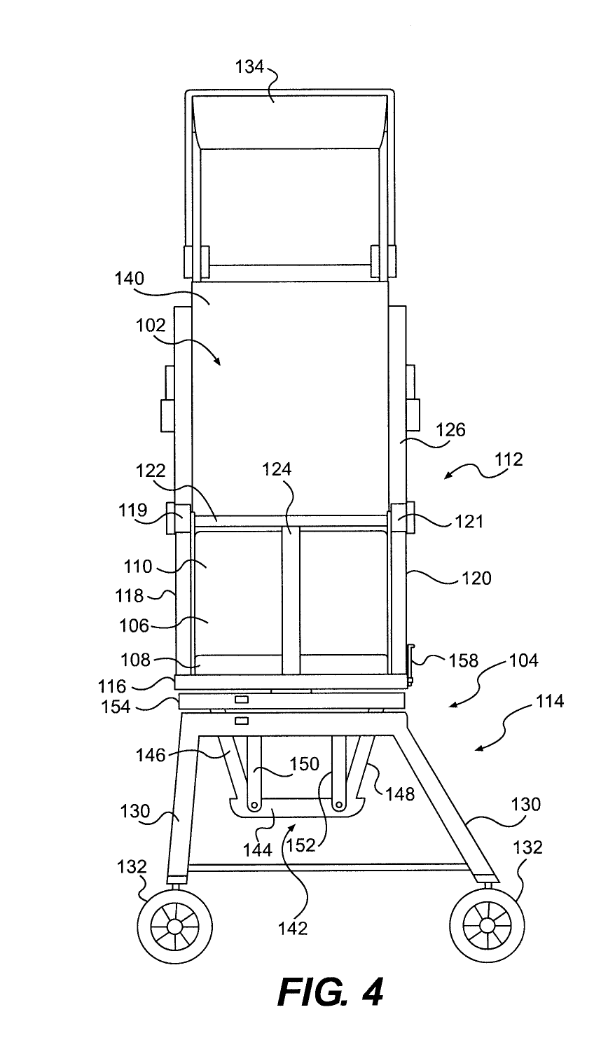

When the first platform 116 is rotated 90 degrees as shown in FIG. 4, the sitting area 102 can be rocked in a side to side motion. For example, the sitting area 102 could be converted as described above into a bassinet, rotated 90 degrees, and then rocked side to side to placate a young child. Referring to FIGS. 2 and 4, a locking mechanism 158 (which may be the same or different from the locking mechanism used to prevent rocking), such as a latch, may be provided to prevent rotation of the first platform 116 with respect to the second platform 154. When the locking mechanism 158 is released, the first platform 116 may be rotated with respect to the second platform 154. It will be appreciated that any suitable locking mechanism may be used to prevent the rotation of the sitting area 102.

In order to resist movement of the stroller 100, either with a child or an adult sitting in the stroller, one or more of the wheels 132 may have a braking mechanism that resists wheel rotation. In other embodiments, the stroller 100 can be made stationary with a support other than the wheels 132. For example, the wheels 132 may be removable such that the legs 130 can rest on the ground to support the stroller 100 as shown in FIG. 3.

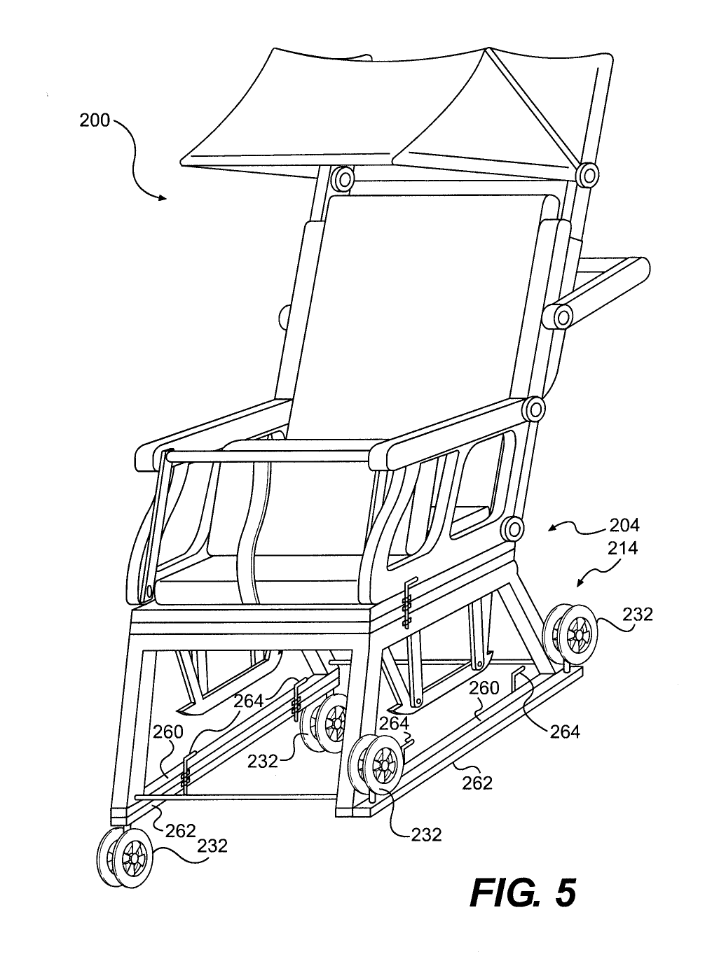

In other embodiments, such as shown in FIG. 5, the stroller frame 204 may have a structure capable of displacing the wheels 232. For example, the wheels 232 may be pivoted in a suitable manner such that they are no longer used to support the stroller 200. As shown, the lower portion 214 of the frame 204 may have base members 260 coupled with hinges or other suitable structures to respective wheel support members 262. The wheels 232 are attached to the wheel support members 262 such that when the wheel support members 262 are pivoted, the wheels 232 are displaced so that the base member 260 can support the stroller 200 in a stationary position. For reference, FIG. 5 shows one side of the stroller 200 supported by the wheels 232 on that side before they are displaced, and the other side of the stroller supportable by a base member 260 when the wheels 232 on the other side are displaced.

One or more locking mechanisms 264 may be used with the base members 260 and wheel support members 262 to prevent the wheel support members 262 from inadvertently pivoting when using the stroller 200. The locking mechanism 264 can be released to permit the wheel support members 262 to pivot. It will be appreciated that any suitable mechanism may be used to prevent the wheel support member 262 from inadvertently pivoting. It will be appreciated that the stroller 200 may be structured in any suitable manner such that stroller 200 can be made stationary with a child or adult sitting in the stroller 200.

It will be appreciated that like shown features in the figures and like reference numbers may represent similar or identical features among the other figures.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A stroller comprising:
a frame;
a handle coupled to the frame;
a plurality of wheels coupled to the frame for moving the stroller; and
a sitting area supported by the frame, the sitting area being convertible between a first seat and a second seat, the first seat being smaller than the second seat.

2. The stroller of claim 1 wherein the first seat includes a seat back and a seat base, and the seat back is moveable to form the second seat.

3. The stroller of claim 2 wherein the seat back is moveable such that the seat back forms part of the second seat.

4. The stroller of claim 1 wherein the first seat has a smaller seat back than a seat back of the second seat.

5. The stroller of claim 1 wherein the first seat has a smaller seat base than a seat base of the second seat.

6. The stroller of claim 1 wherein the depth of the first seat is smaller than the depth of the second seat.

7. The stroller of claim 1 wherein the second seat forms a bassinet.

8. The stroller of claim 1 further comprising a lap bar.

9. The stroller of claim 8 wherein the lap bar is movable.

10. The stroller of claim 1 further comprising a rocking mechanism coupled to the sitting area such that the sitting area is movable in a rocking motion.

11. The stroller of claim 10 wherein the rocking mechanism is a glider rocking mechanism.

12. The stroller of claim 10 further comprising a locking mechanism to prevent the sitting area from rocking.

13. The stroller of claim 1 wherein the frame includes a first portion and a second portion, the sitting area being disposed on the first portion, the first portion being rotatably coupled to the second portion.

14. The stroller of claim 13 further comprising a locking mechanism to prevent the first portion from rotating with respect to the second portion.

15. The stroller of claim 1 wherein the plurality of wheels are mounted to at least one wheel base that is pivotably coupled to the frame such that the plurality of wheels are movable to a position where the wheels do not support the frame.

16. A stroller comprising:
a frame;
a handle coupled to the frame;
a plurality of wheels coupled to the frame for moving the stroller;
a sitting area supported by the frame; and
a rocking mechanism coupled to the sitting area such that the sitting area is movable in a rocking motion.

17. The stroller of claim 16 wherein the rocking mechanism includes a linkage.

18. The stroller of claim 16 wherein the rocking mechanism is a glider rocking mechanism.

19. The stroller of claim 16 further comprising a locking mechanism to prevent the sitting area from rocking.

20. The stroller of claim 16 wherein the frame includes a first portion and a second portion, the sitting area being formed on the first portion, the first portion being rotatably coupled to the second portion.
